(19) United States
(12) Patent Application Publication
(10) Pub. No.: US 2015/0234550 A1
(43) Pub. Date: Aug. 20, 2015

(54) DISPLAY OF DATA ITEMS

(71) Applicant: EMPIRE TECHNOLOGY DEVELOPMENT LLC, Wilmington, DE (US)

(72) Inventors: Seungil Kim, Seoul (KR); Yang-Won Jung, Seoul (KR)

(21) Appl. No.: 14/345,821

(22) PCT Filed: Jun. 18, 2013
(86) PCT No.: PCT/US13/46309

§ 371 Date: Mar. 19, 2014

(51) Int. Cl. G06F 3/0482; G06F 17/30; H04L 29/08

(52) U.S. Cl. CPC G06F 3/0482; H04L 67/306; G06F 17/30876

(57) ABSTRACT

Technologies are generally described for a display management scheme. In some examples, a method may include determining a number of new data items that have not been accessed by a user account, among a plurality of data items; and changing a manner by which respective ones of the new data items that have not been accessed are to be displayed on an electronic device associated with the user account based on, at least, the determined number of new data items.

### BACKGROUND

High-end mobile electronic devices, such as smartphones and tablets, provide ubiquitous network connectivity to the users thereof. For example, a user may use his/her one or more mobile electronic devices to read online data such as an electronic mail, read posts or post him/herself on an SNS (Social Networking Service), read one or more feeds in RSS (Rich Site Summary), or read a news article at anytime and anywhere.

### SUMMARY

In an example, a method may include determining a number of new data items that have not been accessed by a user account, among multiple data items; and changing a manner by which respective ones of the new data items that have not been accessed are to be displayed on an electronic device associated with the user account based on, at least, the determined number of new data items.

In another example, an electronic device may include a new data item determination unit configured to determine a number of new data items that have not been accessed by a user account associated with the electronic device, among multiple data items, in response to launching of an application associated with the multiple data items; and a representation modification unit configured to change a manner by which respective ones of the new data items that have not been accessed are to be displayed on the electronic device based on, at least, the number of new data items determined by the new data item determination unit.

In yet another example, a display management system may include a new data item determination unit configured to determine a number of new data items that have not been accessed by a user account, among multiple data items, in response to a request to access at least one of the multiple data items from an electronic device associated with the user account; a representation modification unit configured to change a manner by which respective ones of the new data items that have not been accessed are to be displayed on the electronic device based on, at least, the number of new data items determined by the new data item determination unit; and a representation generation unit configured to generate a representation to be displayed on the electronic device based on, at least, the changed manner.

In still another example, a computer-readable storage medium may store thereon computer-executable instructions that, in response to execution, cause a processor to perform operations, including determining a number of new data items among multiple data items to be displayed; and adjusting display of one or more of the multiple data items based on, at least, the determined number of new data items.

The foregoing summary is illustrative only and is not intended to be in any way limiting. In addition to the illustrative aspects, embodiments, and features described above, further aspects, embodiments, and features will become apparent by reference to the drawings and the following detailed description.

### BRIEF DESCRIPTION OF THE FIGURES

The foregoing and other features of this disclosure will become more apparent from the following description and appended claims, taken in conjunction with the accompanying drawings. Understanding that these drawings depict only several embodiments in accordance with the disclosure and are, therefore, not to be considered limiting of its scope, the disclosure will be described with additional specificity and detail through use of the accompanying drawings, in which:

FIG. 1 schematically shows an illustrative example of an environment in which a server provides an electronic device with access to data items, arranged in accordance with at least some embodiments described herein;

FIGS. 2(A)-(C) schematically show illustrative examples of screenshots of representations of one or more data items displayed on an electronic device, arranged in accordance with at least some embodiments described herein;

FIG. 3 shows a schematic block diagram illustrating an example architecture of an electronic device for implementing a display management scheme, arranged in accordance with at least some embodiments described herein;

FIG. 4 shows a schematic block diagram illustrating another example architecture of an electronic device for implementing a display management scheme, arranged in accordance with at least some embodiments described herein;

FIG. 5 shows a schematic block diagram illustrating an example architecture of a display manager for implementing a display management scheme, arranged in accordance with at least some embodiments described herein;

FIG. 6 shows a schematic block diagram illustrating an example architecture of a display management system for implementing a display management scheme, arranged in accordance with at least some embodiments described herein;

FIG. 7 shows an example flow diagram of a process for implementing a display management scheme, arranged in accordance with at least some embodiments described herein;

FIG. 8 illustrates an example computer program product that may be utilized to implement a display management scheme, arranged in accordance with at least some embodiments described herein; and

FIG. 9 is a block diagram illustrating an example computing device that may be utilized to implement a display management scheme, arranged in accordance with at least some embodiments described herein.

### DETAILED DESCRIPTION

In the following detailed description, reference is made to the accompanying drawings, which form a part hereof. In the drawings, similar symbols typically identify similar components, unless context dictates otherwise. The illustrative embodiments described in the detailed description, drawings, and claims are not meant to be limiting. Other embodiments may be utilized, and other changes may be made, without departing from the spirit or scope of the subject matter presented herein. It will be readily understood that the aspects of the present disclosure, as generally described herein, and illustrated in the drawings, can be arranged, substituted, combined, separated, and designed in a wide variety of different configurations, all of which are explicitly contemplated herein.

This disclosure is generally drawn, inter alia, to methods, apparatuses, systems, devices, and computer program products related to display management. Further, technologies are herein generally described for displaying, on an electronic device, one or more data items based on, at least, a number of new data items that have not been accessed by a user account for a content source.

In some examples, a user may try to access at least some of multiple data items from the content source (e.g., read electronic mails, SNS (Social Networking Service) posts, RSS (Rich Site Summary) feeds, or news articles, etc.), which may be stored in a server (e.g., an electronic mail server, an SNS server, or an RSS server, etc.), using his/her electronic device. The user may use his/her user account to log on to a server (or one or more segments of a server farm or a server cluster) corresponding to the content source to access the data items.

In some examples, when the user launches on his/her electronic device an application for a content source associated with the multiple data items (e.g., an electronic mail application, an SNS application, an RSS reader application, or a web browser, etc.), the electronic device or the application may determine a number of new data items that have not been accessed by the user account, among the multiple data items stored in the server. Then, the electronic device or the application may change a manner by which respective ones of the new data items are to be displayed thereon based on, at least, the determined number of new data items. By way of example, but not limitation, the electronic device or the application may adjust a size and/or amount of contents of the new data items to be displayed, and/or adjust areas on which the new data items to be displayed. For instance, the electronic device or the application may increase the size and/or amount of contents of the new data items to be displayed and/or the areas on which the new data items to be displayed, as the determined number of new data items decreases. Then, in some examples, the electronic device or the application may display the new data items in accordance with the changed manner.

By way of example, but not limitation, when the user launches an electronic mail application on the electronic device and/or logs on to an electronic mail server that stores multiple electronic mails, the electronic device or the electronic mail application may determine a number of new electronic mails that have not been accessed by the user account (e.g., that have not read by the user), and then adjust the size and/or amount of contents of the new electronic mails to be displayed (e.g., a number of electronic mails to be displayed, and/or how much of a particular electronic mail to be displayed, etc.) based on, at least, the number of new electronic mails. For instance, the electronic device or the electronic mail application may enlarge font size of the respective electronic mails, as the number of new electronic mails decreases. Alternatively and/or additionally, the electronic device or the electronic mail application may change a display manner of the electronic mails from displaying only subjects of the respective electronic mails to displaying subjects, senders, sent times, first sentences, and attachment names of the respective electronic mails, as the number of new electronic mails decreases.

By way of another example, but not limitation, when the user launches an SNS application on the electronic device and/or logs on to an SNS server that stores multiple posts, the electronic device or the SNS application may determine a number of new posts that have not been accessed by the user account (e.g., that have newly posted since the last log-in of the user account), and then adjust the size and/or amount of contents of the new posts to be displayed based on, at least, the number of new posts. For instance, the electronic device or the SNS application may enlarge font size or image size of the respective posts, as the number of new posts decreases. Alternatively and/or additionally, the electronic device or the SNS application may change a display manner of the posts from displaying some of the contents of the respective posts, comments to the respective posts, linked pages of the respective posts, and/or identification of people who expressed their preference with regard to the respective posts, to displaying all or much of the contents of the respective posts, comments to the respective posts, linked pages of the respective posts, and/or identification of people who expressed their preference with regard to the respective posts, as the number of new posts decreases.

In some alternative examples, a display management system hosted by, or in cooperation with, the server may change the manner by which respective ones of the new data items are to be displayed on a respective one of the user's electronic devices. In such cases, the display management system may determine the number of unaccessed new data items, in response to a request to access at least some of the multiple data items from the respective one of the electronic devices, and change the manner by which respective ones of the new data items are to be displayed on the respective one of the electronic devices based on, at least, the determined number of unaccessed new data items. Then, in some examples, the display management system may generate a representation to be displayed on the respective one of the electronic devices based on, at least, the changed manner, and transmit the generated representation to the respective one of the electronic devices.

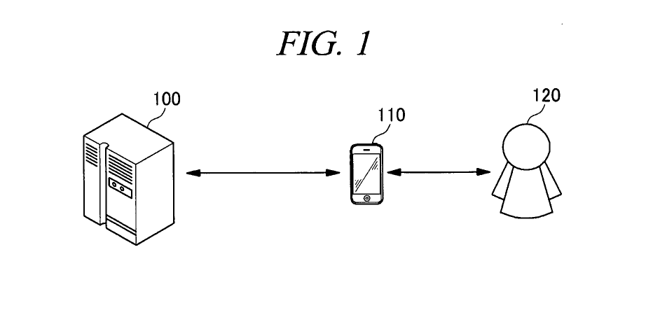

FIG. 1 schematically shows an illustrative example of an environment in which a server 100 provides an electronic device 110 with access to data items, arranged in accordance with at least some embodiments described herein.

As depicted, server 100 may be communicatively coupled to electronic device 110, which may be owned and/or controlled by a user 120, over a network such as, for example, the Internet, a cellular network, a wide area network (WAN), a metropolitan area network (MAN), a local area network (LAN), a campus area network (CAN), a virtual private network (VPN), etc. Server 100 may be associated with a particular content source configured to store and provide for electronic device 110 multiple data items including, but not limited to, electronic mails, posts on a page of an SNS (Social Networking Service), or feeds in an RSS (Rich Site Summary), etc. Electronic device 110 may be of any type of electronic device configured to store, retrieve, compute, transmit and/or receive data, including, for example, a smartphone, a mobile phone, a personal digital assistant (PDA), a tablet, a personal computer such as a laptop computer or a desktop computer, a television, a gaming console, etc.

In some embodiments, server 100 may be configured to identify an association between electronic device 110 and user 120 based on one or more user accounts of user 120 for the particular content source. That is, server 100 may determine that electronic device 110 is owned and/or controlled by user 120 based on the user accounts used by user 120 to log on to server 100 from electronic device 110.

In some embodiments, when user 120 launches on electronic device 110 an application associated with the multiple data items (e.g., an electronic mail application, an SNS application, an RSS reader application, or a web browser, etc.), and/or logs on to server 100 from electronic device 110 using his/her user account, electronic device 110 or the application may determine a number of new data items that have not been accessed by the user account, among the multiple data items. By way of example, but not limitation, when the data items are electronic mails, the new data items may be electronic mails that have not been accessed by the user account, and the application may be an electronic mail application. By way of another example, but not limitation, when the data items are posts on a page of an SNS, the new data items may be posts that have not been accessed by the user account, and the application may be an SNS application. By way of yet another example, but not limitation, when the data items are feeds in an RSS, the new data items may be feeds that have not been accessed by the user account, and the application may be an RSS reader application.

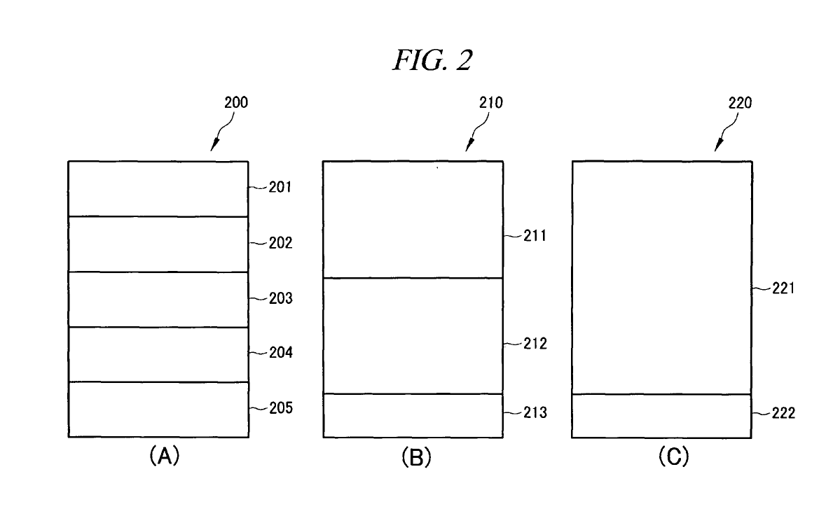

Then, in some embodiments, electronic device 110 or the application may change a manner by which respective ones of the new data items are to be displayed on electronic device 110 based on, at least, the determined number of unaccessed new data items. By way of example, but not limitation, electronic device 110 or the application may adjust a size and/or amount of contents of the new data items to be displayed. For instance, electronic device 110 or the application may increase the size and/or amount of contents of the new data items to be displayed as the number of new data items decreases. Alternatively and/or additionally, electronic device 110 or the application may change the manner by which the respective ones of the new data items are to be displayed on electronic device 110, when the determined number of new data items is less than a predetermined threshold value. The example embodiments of adjusting the size and/or amount of contents of the new data items to be displayed will be described in more detail below with reference to FIGS. 2(A)-(C).

In some alternative embodiments, a display management system (not shown in FIG. 1, but described in more detail below) hosted by or in cooperation with server 100, instead of electronic device 110 or the application, may perform the above-described operations of determining the number of new data items and/or changing the manner by which respective ones of the new data items are to be displayed on electronic device 110.

FIGS. 2(A)-(C) schematically show illustrative examples of screenshots of representations 200, 210 and 220 of one or more data items displayed on electronic device 110, arranged in accordance with at least some embodiments described herein.

As depicted in FIGS. 2(A)-(C), representation 200 may include data items 201, 202, 203, 204 and 205; representation 210 may include data items 211, 212 and 213; and representation 220 may include data items 221 and 222. Representations 200, 210 and 220 may be displayed on electronic device 110 as shown in FIG. 1. In some embodiments, data items 211, 212 and 213 in representation 210 may be presented with more content and/or more visual clarity (e.g., due to larger font or image size) than data items 201, 202, 203, 204 and 205 in representation 200; and data items 221 and 222 in representation 220 may be presented with more content and/or more visual clarity than data items 211, 212 and 213 in representation 210.

In some embodiments, in which data items 201 to 205, 211 to 213, 221 and 222 are electronic mails, electronic device 110 or an electronic mail application executing on electronic device 110 may generate representations 200 to include data items 201 to 205 when a number of new electronic mails that have not been accessed by a user account (e.g., that have not been read by a user) is higher than a first threshold value, generate representation 210 to include data items 211 to 213 when the number of new electronic mails is not higher than the first threshold value but higher than a second threshold value (that is less than the first threshold value), and generate representation 220 to include data items 221 and 222 when the number of new electronic mails is not higher than the second threshold value. The first and second threshold values may be any number (e.g., 1, 2, 3, 5, 10, etc.) that may depend on, at least, a screen size of electronic device 110. By way of example, but not limitation, data items 221 and 222 in representation 220 may have larger font size than data items 211 to 213 in representation 210, and data items 211 to 213 in representation 210 may have larger font size than data items 201 to 205 in representation 200. By way of further example, but not limitation, data items 221 and 222 in representation 220 may display any one or more of subjects, senders, sent times, first sentences, and attachment names of respective data items 221 and 222; data items 211 to 213 in representation 210 may display any one or more of subjects, senders, sent times, and first sentences of respective data items 211 to 213; and data items 201 to 205 in representation 200 may display any one or more of subjects and senders of respective data items 201 to 205.

In some other embodiments in which data items 201 to 205, 211 to 213, 221 and 222 are posts on a page of an SNS (Social Networking Service), electronic device 110 or an SNS application run on electronic device 110 may generate representations 200 to include data items 201 to 205 when a number of new posts that have not been accessed by a user account (e.g., that have been newly posted since the last log-in of the user account) is higher than a first threshold value, generate representation 210 to include data items 211 to 213 when the number of new posts is not higher than the first threshold value but higher than a second threshold value (that is less than the first threshold value), and generate representation 220 to include data items 221 and 222 when the number of new posts is not higher than the second threshold value. The first and second threshold values may be any number (e.g., 1, 2, 3, 5, 10, etc.) that may depend on, at least, a screen size of electronic device 110. By way of example, but not limitation, data items 221 and 222 in representation 220 may have larger font size and/or image size than data items 211 to 213 in representation 210, and data items 211 to 213 in representation 210 may have larger font size and/or image size than data items 201 to 205 in representation 200. By way of further example, but not limitation, data items 221 and 222 in representation 220 may display more contents, comments, linked pages, and/or identification of people who expressed their preference than data items 211 to 213 in representation 210; and data items 211 to 213 in representation 210 may display more contents, comments, linked pages, and/or identification of people who expressed their preference than data items 201 to 205 in representation 200.

Although FIGS. 2(A)-(C) illustrate three levels of different representations of data items in accordance with variance of a number of new data items, those skilled in the art will readily appreciate that any number of levels of different representations of data items may be available depending on a desired implementation.

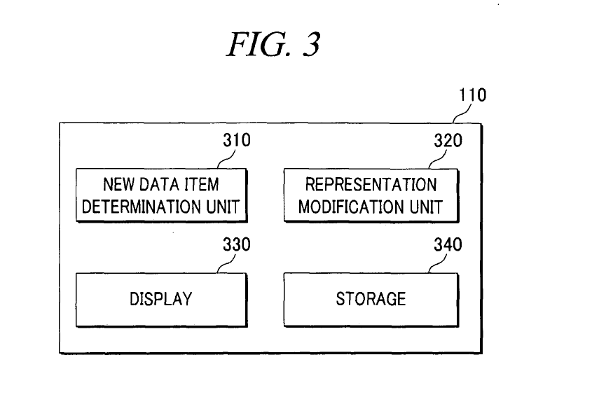

FIG. 3 shows a schematic block diagram illustrating an example architecture of electronic device 110 for implementing a display management scheme, arranged in accordance with at least some embodiments described herein. Reference may be made to the embodiments depicted and described with reference to FIGS. 1-2.

As depicted, electronic device 110 may include a new data item determination unit 310, a representation modification unit 320, a display 330, and a storage 340. Although illustrated as discrete components, various components may be divided into additional components, combined into fewer components, or eliminated while being contemplated within the scope of the disclosed subject matter. It will be understood by those skilled in the art that each function and/or operation of the components may be implemented, individually and/or collectively, by a wide range of hardware, software, firmware, or virtually any combination thereof.

New data item determination unit 310 may be configured to determine a number of new data items that have not been accessed by a user account associated with electronic device 110 corresponding to a particular content source, among multiple data items, in response to launching of an application associated with the multiple data items. By way of example, but not limitation, when the data items are electronic mails, the new data items may be electronic mails that have not been accessed by the user account, and the application may be an electronic mail application; when the data items are posts on a page of an SNS, the new data items may be posts that have not been accessed by the user account, and the application may be an SNS application; and when the data items are feeds in an RSS, the new data items may be feeds that have not been accessed by the user account, and the application may be an RSS reader application.

Representation modification unit 320 may be configured to change a manner by which respective ones of the new data items that have not been accessed are to be displayed on electronic device 110 based on, at least, the number of new data items determined by new data item determination unit 310. In some embodiments, representation modification unit 320 may be configured to adjust a size and/or amount of contents of the new data items to be displayed based on, at least, the number of new data items determined by new data item determination unit 310. For instance, representation modification unit 320 may be configured to increase the size and/or amount of contents of the new data items to be displayed as the number of new unaccessed data items decreases. Alternatively and/or additionally, representation modification unit 320 may be configured to change the manner by which the respective ones of the new data items are to be displayed on electronic device 110, when the number of new data items determined by new data item determination unit 310 is less than a predetermined threshold value. The predetermined threshold value may vary depending on, at least, a screen size of electronic device 110.

Display 330 may be configured to display the new data items in accordance with the changed manner determined by representation modification unit 320. Further, storage 340 may be configured to store the multiple data items.

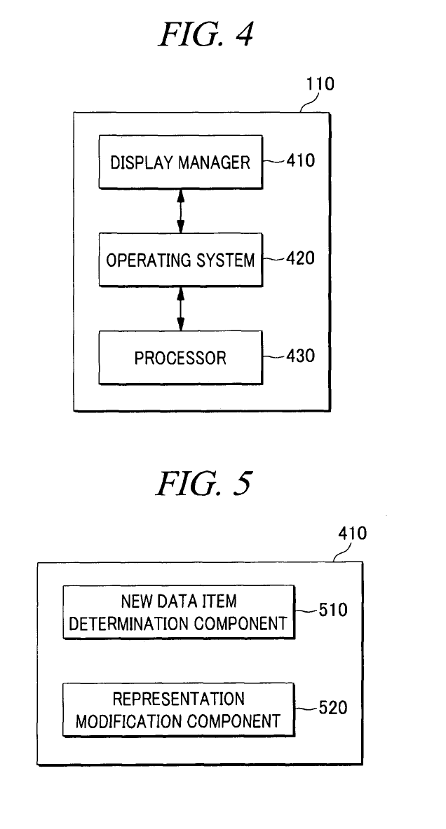

FIG. 4 shows a schematic block diagram illustrating another example architecture of electronic device 110 for implementing a display management scheme, arranged in accordance with at least some embodiments described herein. Reference may be made to the embodiments depicted and described with reference to FIGS. 1-3.

As depicted, electronic device 110 may include a display manager 410, an operating system 420 and a processor 430. In some embodiments, display manager 410 may be a part of an application associated with multiple data items (e.g., an electronic mail application, an SNS application, an RSS reader application, or a web browser, etc.). Display manager 410 may be adapted to operate on operating system 420 such that the display management scheme, as described herein, may be provided. Operating system 420 may allow display manager 410 to manipulate processor 430 to implement the display management scheme as described herein.

FIG. 5 shows a schematic block diagram illustrating an example architecture of display manager 410 for implementing a display management scheme, arranged in accordance with at least some embodiments described herein. Reference may be made to the embodiments depicted and described with reference to FIGS. 1-4.

As depicted, display manager 410 may include a new data item determination component 510 and a representation modification component 520. New data item determination component 510 may be adapted to determine a number of new data items that have not been accessed by a user account associated with electronic device 110 corresponding to a particular content source, among multiple data items that may be stored in server 100 (in FIG. 1). Further, representation modification component 520 may be adapted to change a manner by which respective ones of the new data items that have not been accessed are to be displayed on electronic device 110 based on, at least, the number of new data items determined by new data item determination component 510.

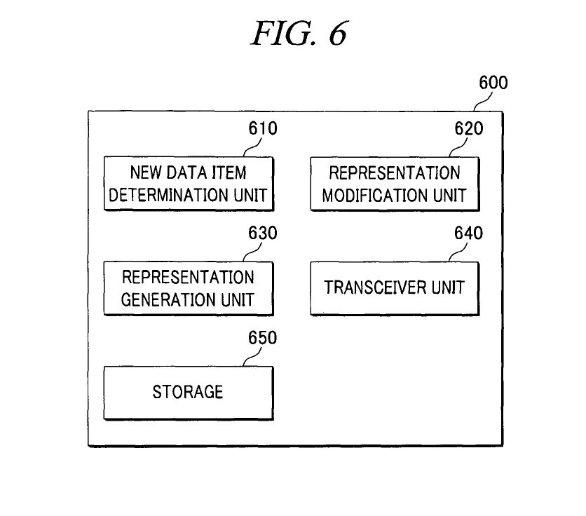

FIG. 6 shows a schematic block diagram illustrating an example architecture of a display management system 600 for implementing a display management scheme, arranged in accordance with at least some embodiments described herein. Reference may be made to the embodiments depicted and described with reference to FIGS. 1-2.

In some embodiments, display management system 600 may be hosted by or in cooperation with server 100 (as shown in FIG. 1). As depicted, display management system 600 may include a new data item determination unit 610, a representation modification unit 620, a representation generation unit 630, a transceiver unit 640, and a storage 650. Although illustrated as discrete components, various components may be divided into additional components, combined into fewer components, or eliminated while being contemplated within the scope of the disclosed subject matter. It will be understood by those skilled in the art that each function and/or operation of the components may be implemented, individually and/or collectively, by a wide range of hardware, software, firmware, or any combination thereof.

New data item determination unit 610 may be configured to determine a number of new data items that have not been accessed by a user account of a particular content source, among multiple data items, in response to a request to access at least one of the multiple data items from electronic device 110. By way of example, but not limitation, when the data items are electronic mails, the new data items may be electronic mails that have not been accessed by the user account, and display management system 600 may be hosted by an electronic mail service provider; when the data items are posts on a page of an SNS, the new data items may be posts that have not been accessed by the user account, and display management system 600 may be hosted by an SNS service provider; and when the data items are feeds in an RSS, the new data items may be feeds that have not been accessed by the user account, and display management system 600 may be hosted by an RSS service provider.

Representation modification unit 620 may be configured to change a manner by which respective ones of the new data items that have not been accessed are to be displayed on electronic device 110 based on, at least, the number of new data items determined by new data item determination unit 610. In some embodiments, representation modification unit 620 may be configured to adjust a size and/or amount of contents of the new data items to be displayed based on, at least, the number of new data items determined by new data item determination unit 610. For instance, representation modification unit 620 may be configured to increase the size and/or amount of contents of the new data items to be displayed as the number of new data items decreases. Alternatively and/or additionally, representation modification unit 620 may be configured to change the manner by which the respective ones of the new data items are to be displayed on electronic device 110, when the number of new data items determined by new data item determination unit 610 is less than a predetermined threshold value. The predetermined threshold value may vary depending on, at least, a screen size of electronic device 110.

Representation generation unit 630 may be configured to generate a representation to be displayed on electronic device 110 based on, at least, the changed manner. Further, transceiver unit 640 may be configured to receive the request to access from electronic device 110, and to transmit the generated representation to electronic device 110. In addition, storage 650 may be configured to store the multiple data items.

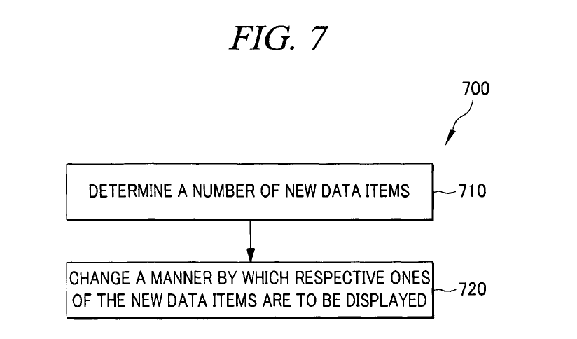

FIG. 7 shows an example flow diagram of a process for implementing a display management scheme, arranged in accordance with at least some embodiments described herein.

Process 700 may be implemented in an electronic device such as electronic device 110 including new data item determination unit 310, representation modification unit 320, display 330, and storage 340. Process 700 may also be implemented by computer programs or program modules that are adapted to provide a display management scheme and hosted by electronic device 110, such as display manager 410 including new data item determination component 510 and representation modification component 520. Process 700 may also be implemented by a display management system such as display management system 600 including new data item determination unit 610, representation modification unit 620, representation generation unit 630, transceiver unit 640, and storage 650. Thus, reference may be made to the embodiments depicted and described with reference to FIGS. 1-6. Process 700 may include one or more operations, actions, or functions as illustrated by one or more blocks 710 and/or 720. Although illustrated as discrete blocks, various blocks may be divided into additional blocks, combined into fewer blocks, or eliminated, depending on the desired implementation. Processing may begin at block 710.

At block 710 (Determine a Number of New Data Items), electronic device 110, display manager 410 and/or display management system 600 may determine a number of new data items that have not been accessed by a user account of a particular content source, among multiple data items that may be stored in server 100 (as shown in FIG. 1). By way of example, but not limitation, the number of new data items may be a number of new electronic mails that have not been read by the user account, a number of new SNS posts that have been newly posted since the last log-in of the user account, etc. Processing may continue from block 710 to block 720.

At block 720 (Change a Manner by which Respective Ones of the New Data Items are to be Displayed), electronic device 110, display manager 410 and/or display management system 600 may change a manner by which respective ones of the new data items that have not been accessed are to be displayed on electronic device 110 based on, at least, the determined number of new unaccessed data items. In some embodiments, electronic device 110, display manager 410 and/or display management system 600 may adjust a size and/or amount of contents of the new data items to be displayed.

As such, the new data items in a feed may be displayed with more content and/or more visual clarity, if there are few new data items in the feed, thereby utilizing user's display capability more effectively.

One skilled in the art will appreciate that, for this and other processes and methods disclosed herein, the functions performed in the processes and methods may be implemented in differing order. Furthermore, the outlined steps and operations are only provided as examples, and some of the steps and operations may be optional, combined into fewer steps and operations, or expanded into additional steps and operations without detracting from the essence of the disclosed embodiments.

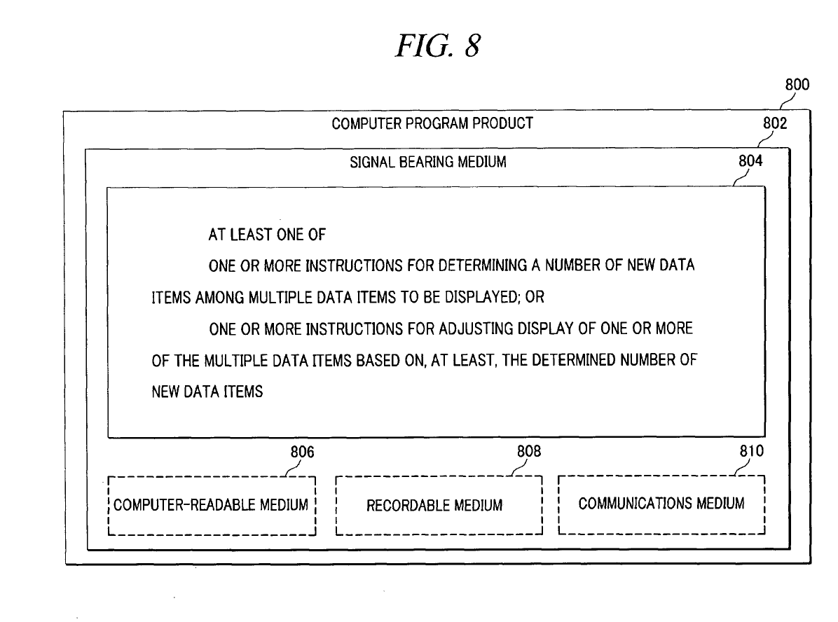

FIG. 8 illustrates an example computer program product 800 that may be utilized to implement a display management scheme, arranged in accordance with at least some embodiments described herein.

As depicted, program product 800 may include a signal bearing medium 802. Signal bearing medium 802 may include one or more instructions 804 that, when executed by, for example, a processor of electronic device 110 or display management system 600, may provide the functionality described above with respect to FIGS. 1-7. By way of example, instructions 804 may include: one or more instructions for determining a number of new data items among multiple data items to be displayed; or one or more instructions for adjusting display of one or more of the multiple data items based on, at least, the determined number of new data items.

In some implementations, signal bearing medium 802 may encompass a computer-readable medium 806, such as, but not limited to, a hard disk drive, a CD, a DVD, a digital tape, memory, etc. In some implementations, signal bearing medium 802 may encompass a recordable medium 808, such as, but not limited to, memory, read/write (R/W) CDs, R/W DVDs, etc. In some implementations, signal bearing medium 802 may encompass a communications medium 810, such as, but not limited to, a digital and/or an analog communication medium (e.g., a fiber optic cable, a waveguide, a wired communications link, a wireless communication link, etc.). Thus, for example, program product 800 may be conveyed to one or more modules of electronic device 110 and/or display management system 600 by an RF signal bearing medium 802, where the signal bearing medium 802 is conveyed by a wireless communications medium 810 (e.g., a wireless communications medium conforming with the IEEE 802.11 standard).

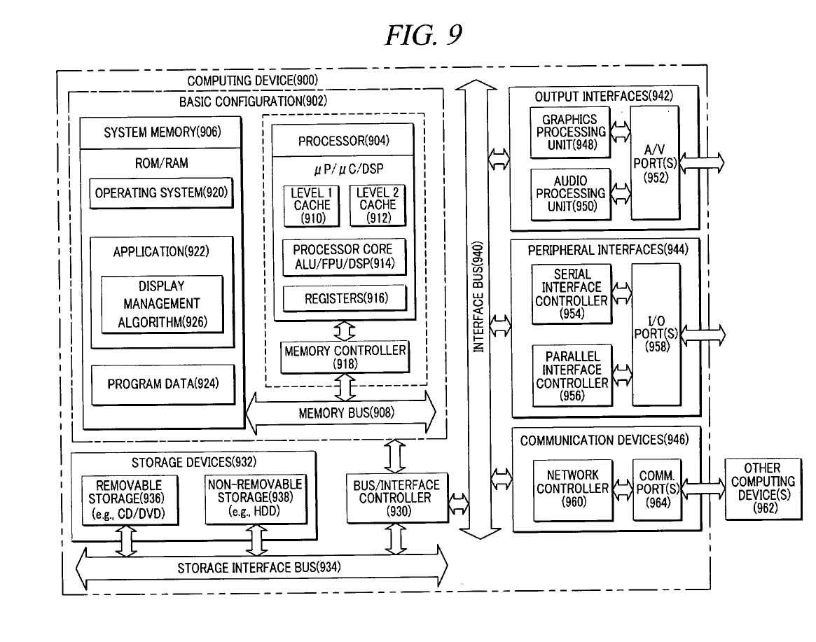

FIG. 9 is a block diagram illustrating an example computing device 900 that may be utilized to implement a display management scheme, arranged in accordance with at least some embodiments described herein.

In a very basic configuration 902, computing device 900 typically includes one or more processors 904 and a system memory 906. A memory bus 908 may be used for communicating between processor 904 and system memory 906.

Depending on the desired configuration, processor 904 may be of any type including but not limited to a microprocessor (μP), a microcontroller (μC), a digital signal processor (DSP), or any combination thereof. Processor 904 may include one or more levels of caching, such as a level one cache 910 and a level two cache 912, a processor core 914, and registers 916. An example processor core 914 may include an arithmetic logic unit (ALU), a floating point unit (FPU), a digital signal processing core (DSP Core), or any combination thereof. An example memory controller 918 may also be used with processor 904, or in some implementations memory controller 918 may be an internal part of processor 904.

Depending on the desired configuration, system memory 906 may be of any type including but not limited to volatile memory (such as RAM), non-volatile memory (such as ROM, flash memory, etc.) or any combination thereof. System memory 906 may include an operating system 920, one or more applications 922, and program data 924.

Application 922 may include a display management algorithm 926 that may be arranged to perform the functions as described herein including the actions described with respect to the electronic device 110 architecture as shown in FIGS. 3-5 and/or display management system 600 architecture as shown in FIG. 6 or including the actions described with respect to the flow chart shown in FIG. 7. Program data 924 may include any data that may be useful for providing the display management scheme as is described herein. In some examples, application 922 may be arranged to operate with program data 924 on an operating system 920 such that the display management scheme as described herein may be provided.

Computing device 900 may have additional features or functionality, and additional interfaces to facilitate communications between basic configuration 902 and any required devices and interfaces. For example, a bus/interface controller 930 may be used to facilitate communications between basic configuration 902 and one or more data storage devices 932 via a storage interface bus 934. Data storage devices 932 may be removable storage devices 936, non-removable storage devices 938, or a combination thereof. Examples of removable storage and non-removable storage devices include magnetic disk devices such as flexible disk drives and hard-disk drives (HDD), optical disk drives such as compact disk (CD) drives or digital versatile disk (DVD) drives, solid state drives (SSD), and tape drives to name a few. Example computer storage media may include volatile and nonvolatile, removable and non-removable media implemented in any method or technology for storage of information, such as computer readable instructions, data structures, program modules, or other data.

System memory 906, removable storage devices 936 and non-removable storage devices 938 arc examples of computer storage media. Computer storage media includes, but is not limited to, RAM, ROM, EEPROM, flash memory or other memory technology, CD-ROM, digital versatile disks (DVD) or other optical storage, magnetic cassettes, magnetic tape, magnetic disk storage or other magnetic storage devices, or any other medium which may be used to store the desired information and which may be accessed by computing device 900. Any such computer storage media may be part of computing device 900.

Computing device 900 may also include an interface bus 940 for facilitating communication from various interface devices (e.g., output devices 942, peripheral interfaces 944, and communication devices 946) to basic configuration 902 via bus/interface controller 930. Example output devices 942 include a graphics processing unit 948 and an audio processing unit 950, which may be configured to communicate to various external devices such as a display or speakers via one or more A/V ports 952. Example peripheral interfaces 944 include a serial interface controller 954 or a parallel interface controller 956, which may be configured to communicate with external devices such as input devices (e.g., keyboard, mouse, pen, voice input device, touch input device, etc.) or other peripheral devices (e.g., printer, scanner, etc.) via one or more I/O ports 958. An example communication device 946 includes a network controller 960, which may be arranged to facilitate communications with one or more other computing devices 962 over a network communication link via one or more communication ports 964.

The network communication link may be one example of a communication media. Communication media may typically be embodied by computer readable instructions, data structures, program modules, or other data in a modulated data signal, such as a carrier wave or other transport mechanism, and may include any information delivery media. A “modulated data signal” may be a signal that has one or more of its characteristics set or changed in such a manner as to encode information in the signal. By way of example, and not limitation, communication media may include wired media such as a wired network or direct-wired connection, and wireless media such as acoustic, radio frequency (RF), microwave, infrared (IR) and other wireless media. The term computer readable media as used herein may include both storage media and communication media.

Computing device 900 may be implemented as a portion of a small-form factor portable (or mobile) electronic device such as a cell phone, a personal data assistant (PDA), a personal media player device, a wireless web-watch device, a personal headset device, an application specific device, or a hybrid device that include any of the above functions. Computing device 900 may also be implemented as a personal computer including both laptop computer and non-laptop computer configurations.

The present disclosure is not to be limited in terms of the particular embodiments described in this application, which are intended as illustrations of various aspects. Many modifications and variations can be made without departing from its spirit and scope, as will be apparent to those skilled in the art. Functionally equivalent methods and apparatuses within the scope of the disclosure, in addition to those enumerated herein, will be apparent to those skilled in the art from the foregoing descriptions. Such modifications and variations are intended to fall within the scope of the appended claims. The present disclosure is to be limited only by the terms of the appended claims, along with the full scope of equivalents to which such claims are entitled. It is to be understood that this disclosure is not limited to particular methods, reagents, compounds, compositions or biological systems, which can, of course, vary. It is also to be understood that the terminology used herein is for the purpose of describing particular embodiments only, and is not intended to be limiting.

With respect to the use of substantially any plural and/or singular terms herein, those having skill in the art can translate from the plural to the singular and/or from the singular to the plural as is appropriate to the context and/or application. The various singular/plural permutations may be expressly set forth herein for sake of clarity.

It will be understood by those within the art that, in general, terms used herein, and especially in the appended claims (e.g., bodies of the appended claims) are generally intended as “open” terms (e.g., the term “including” should be interpreted as “including but not limited to,” the term “having” should be interpreted as “having at least,” the term “includes” should be interpreted as “includes but is not limited to,” etc.). It will be further understood by those within the art that if a specific number of an introduced claim recitation is intended, such an intent will be explicitly recited in the claim, and in the absence of such recitation no such intent is present. For example, as an aid to understanding, the following appended claims may contain usage of the introductory phrases “at least one” and “one or more” to introduce claim recitations. However, the use of such phrases should not be construed to imply that the introduction of a claim recitation by the indefinite articles “a” or “an” limits any particular claim containing such introduced claim recitation to embodiments containing only one such recitation, even when the same claim includes the introductory phrases “one or more” or “at least one” and indefinite articles such as “a” or “an” (e.g., “a” and/or “an” should be interpreted to mean “at least one” or “one or more”); the same holds true for the use of definite articles used to introduce claim recitations. In addition, even if a specific number of an introduced claim recitation is explicitly recited, those skilled in the art will recognize that such recitation should be interpreted to mean at least the recited number (e.g., the bare recitation of “two recitations,” without other modifiers, means at least two recitations, or two or more recitations). Furthermore, in those instances where a convention analogous to “at least one of A, B, and C, etc.” is used, in general such a construction is intended in the sense one having skill in the art would understand the convention (e.g., “a system having at least one of A, B, and C” would include but not be limited to systems that have A alone, B alone, C alone, A and B together, A and C together, B and C together, and/or A, B, and C together, etc.). In those instances where a convention analogous to “at least one of A, B, or C, etc.” is used, in general such a construction is intended in the sense one having skill in the art would understand the convention (e.g., “a system having at least one of A, B, or C” would include but not be limited to systems that have A alone, B alone, C alone, A and B together, A and C together, B and C together, and/or A, B, and C together, etc.). It will be further understood by those within the art that virtually any disjunctive word and/or phrase presenting two or more alternative terms, whether in the description, claims, or drawings, should be understood to contemplate the possibilities of including one of the terms, either of the terms, or both terms. For example, the phrase “A or B” will be understood to include the possibilities of “A” or “B” or “A and B.”

In addition, where features or aspects of the disclosure are described in terms of Markush groups, those skilled in the art will recognize that the disclosure is also thereby described in terms of any individual member or subgroup of members of the Markush group.

As will be understood by one skilled in the art, for any and all purposes, such as in terms of providing a written description, all ranges disclosed herein also encompass any and all possible subranges and combinations of subranges thereof. Any listed range can be easily recognized as sufficiently describing and enabling the same range being broken down into at least equal halves, thirds, quarters, fifths, tenths, etc. As a non-limiting example, each range discussed herein can be readily broken down into a lower third, middle third and upper third, etc. As will also be understood by one skilled in the art all language such as “up to,” “at least,” and the like include the number recited and refer to ranges which can be subsequently broken down into subranges as discussed above. Finally, as will be understood by one skilled in the art, a range includes each individual member. Thus, for example, a group having 1-3 cells refers to groups having 1, 2, or 3 cells. Similarly, a group having 1-5 cells refers to groups having 1, 2, 3, 4, or 5 cells, and so forth.

From the foregoing, it will be appreciated that various embodiments of the present disclosure have been described herein for purposes of illustration, and that various modifications may be made without departing from the scope and spirit of the present disclosure. Accordingly, the various embodiments disclosed herein are not intended to be limiting, with the true scope and spirit being indicated by the following claims.

1. A method comprising:
determining a number of new data items that have not been accessed by a user account, among a plurality of data items; and
changing a manner by which respective ones of the new data items that have not been accessed are to be displayed on an electronic device associated with the user account based on, at least, the determined number of new data items.

2. The method of claim 1, wherein the changing comprises adjusting a size and/or amount of contents of the new data items to be displayed.

3. The method of claim 1, wherein the changing comprises increasing a size and/or amount of contents of the new data items to be displayed as the determined number of new data items decreases.

4. The method of claim 1, wherein the changing comprises adjusting areas on which the respective ones of the new data items to be displayed.

5. The method of claim 1, wherein the changing comprises changing the manner by which the respective ones of the new data items that have not been accessed are to be displayed on the electronic device, when the determined number of new data items is less than a predetermined threshold value.

6. The method of claim 1, further comprising:
displaying on the electronic device the new data items that have not been accessed in accordance with the changed manner.

7. The method of claim 1, wherein the data items are electronic mails, and the new data items are electronic mails that have not been accessed by the user account.

8. The method of claim 1, wherein the data items are posts on a page of an SNS (Social Networking Service), and the new data items are posts that have not been accessed by the user account.

9. The method of claim 1, wherein the data items are feeds in RSS (Rich Site Summary), and the new data items are feeds that have not been accessed by the user account.

10. An electronic device comprising:
a new data item determination unit configured to determine a number of new data items that have not been accessed by a user account associated with the electronic device, among a plurality of data items, in response to launching of an application associated with the plurality of data items; and
a representation modification unit configured to change a manner by which respective ones of the new data items that have not been accessed are to be displayed on the electronic device based on, at least, the number of new data items determined by the new data item determination unit.

11. The electronic device of claim 10, wherein the data items are electronic mails, the new data items are electronic mails that have not been accessed by the user account, and the application is an electronic mail application.

12. The electronic device of claim 10, wherein the data items are posts on a page of an SNS (Social Networking Service), the new data items are posts that have not been accessed by the user account, and the application is an SNS application.

13. The electronic device of claim 10, wherein the data items are feeds in RSS (Rich Site Summary), the new data items are feeds that have not been accessed by the user account, and the application is an RSS reader application.

14. The electronic device of claim 10, wherein the representation modification unit is further configured to adjust a size and/or amount of contents of the new data items to be displayed based on, at least, the number of new data items determined by the new data item determination unit.

15. The electronic device of claim 10, wherein the representation modification unit is further configured to increase a size and/or amount of contents of the new data items to be displayed as the number of new data items decreases.

16. The electronic device of claim 10, wherein the representation modification unit is further configured to change the manner by which the respective ones of the new data items that have not been accessed are to be displayed on the electronic device, when the number of new data items determined by the new data item determination unit is less than a predetermined threshold value.

17. The electronic device of claim 10, further comprising:
a display configured to display the new data items that have not been accessed in accordance with the changed manner.

18. The electronic device of claim 10, further comprising:
a storage configured to store the plurality of data items.

19. A display management system comprising:
a new data item determination unit configured to determine a number of new data items that have not been accessed by a user account, among a plurality of data items, in response to a request to access at least one of the plurality of data items from an electronic device associated with the user account;
a representation modification unit configured to change a manner by which respective ones of the new data items that have not been accessed are to be displayed on the electronic device based on, at least, the number of new data items determined by the new data item determination unit; and
a representation generation unit configured to generate a representation to be displayed on the electronic device based on, at least, the changed manner.

20. The display management system of claim 19, further comprising:
a transceiver unit configured to receive the request to access from the electronic device, and to transmit the generated representation to the electronic device.

21. The display management system of claim 19, wherein the data items are electronic mails, the new data items are electronic mails that have not been accessed by the user account, and the display management system is hosted by an electronic mail service provider.

22. The display management system of claim 19, wherein the data items are posts on a page of an SNS (Social Networking Service), the new data items are posts that have not been accessed by the user account, and the display management system is hosted by an SNS service provider.

23. The display management system of claim 19, wherein the data items are feeds in RSS (Rich Site Summary), the new data items are feeds that have not been accessed by the user account, and the display management system is hosted by an RSS service provider.

24. The display management system of claim 19, wherein the representation modification unit is further configured to adjust a size and/or amount of contents of the new data items to be displayed based on, at least, the number of new data items determined by the new data item determination unit.

25. The display management system of claim 19, wherein the representation modification unit is further configured to increase a size and/or amount of contents of the new data items to be displayed as the number of new data items decreases.

26. The display management system of claim 19, wherein the representation modification unit is further configured to change the manner by which the respective ones of the new data items that have not been accessed are to be displayed on the electronic device, when the number of new data items determined by the new data item determination unit is less than a predetermined threshold value.

27. The display management system of claim 19, further comprising:
a storage configured to store the plurality of data items.

28. A non-transitory computer-readable storage medium having stored thereon computer-executable instructions that, in response to execution, cause a processor to perform operations, comprising:
determining a number of new data items that have not been accessed by a user account among a plurality of data items to be displayed on an electronic device associated with the user account; and
adjusting display of one or more of the plurality of data items based on, at least, the determined number of new data items.
